(19) United States
(12) Patent Application Publication
(10) Pub. No.: US 2006/0118708 A1
(43) Pub. Date: Jun. 8, 2006

(54) Optical detection device for a counter

(75) Inventors: Laurent Demia, Montluel (FR); Serge Bulteau, Julienas (FR); Alain Cros, Creches sur Saone (FR)

Correspondence Address: SOFER & HAROUN LLP., 317 MADISON AVENUE, SUITE 910, NEW YORK, NY, 10017, US

(73) Assignee: Actaris Sas, Boulogne Billancourt (FR)

(21) Appl. No.: 10/536,477

(22) PCT Filed: Jan. 30, 2004
(86) PCT No.: PCT/FR04/00233

§ 371 Date: Dec. 8, 2005

(30) Foreign Application Priority Data
Feb. 5, 2003 (FR) 03/01318

(51) Int. Cl. G01D 5/34

(52) U.S. Cl. 250/231.13

(57) ABSTRACT

An optical detection device for a counter, comprising a consumption indicator, formed from a rotating target (4) and optical elements of the emitter type and receiver type, at least one of which is opposite the target, the received optical signal from which is used to infer the number of rotations of the disc. The above comprises at least two optical elements (6A, 6B) of one type and at least one optical element (7) of the other type. The target (4A) is an opaque disc section with a centre angle, called the first angle (γ), of 45 to 225°. The two optical elements of one type (6A, 6B) are emitter elements of a beam of light, the beam of light lies outside the target (4) and the device further comprises at least one mirror (4A, 4B), reflecting each optical beam onto the target trajectory.

The present invention pertains to an optical detector device for a meter, a fluid meter in particular e.g. water, to enable remote readout of the consumption of this water meter, or equivalent operations of logging or alert type.

More precisely it concerns an optical detector device for a meter, comprising a consumption indicator formed of a rotating target and optical elements of emitting and receiving type of which at least one lies opposite said target, whose received optical signal is processed to infer at least the number of rotations of said target, comprising at least two said optical elements of one type and at least one said optical element of the other type.

Said device is known from patent EP 0 380 794.

According to this document, the device comprises an optical detector which is arranged outside the meter and which is adapted to produce an effective signal whenever an index or active sector arranged on a disc passes in front of the detector. This signal is amplified and converted into a square wave so that it can be sent onto a data transmission network. With said detection device, it is possible to determine the number of disc rotations but it is not possible to determine the direction of rotation of this disc.

Yet a fluid meter, in particular a water meter, can operate both on fluid input and on fluid output. This is the case for example when water mains are emptied during construction works, or on flow surges causing water return movement.

The consumption display device, for example an arrangement of dials with digits, takes this into consideration.

The purpose of the invention is to provide an optical detector device able to determine the direction of flow of the water and hence the direction of rotation of the indicating disc so as to take into account consumption which can be termed negative and to provide identical consumption data to the data provided by the conventional display device of the meter.

For this purpose, the invention proposes an optical detector device for a meter comprising a consumption indicator formed of a rotating target and optical elements of emitting type and receiving type of at least one lies opposite said target, and whose received optical signal is processed to infer at least the number of rotations of said target, comprising at least two said optical elements of one type and at least one said optical element of the other type, characterized in that said target is a portion of an opaque disc with a centre angle called first angle lying between 45 and 225°, and said second optical elements of one type are elements emitting a light beam whose light beam is outside the target, and in that it also comprises two mirrors reflecting each optical beam on the pathway of the target.

These optical elements may be integrated in one same component and an appropriate cover on the meter and module may limit stray light beams.

The disc portion preferably has a centre angle of 180°.

The choice of an opaque disc having a centre angle of 180° ensures optimisation of the frequency of the transmitter element or elements in relation to electric power consumption. Said meters or said modules are battery powered and it is highly advantageous that they should have low power consumption. A single light beam sequence may be chosen which is optimal irrespective of detected states. This single sequence ensures equilibrium of states in terms of angle and duration at constant speed.

Preferably the optical detector of the invention comprises two emitting optical elements and one receiving optical element.

This embodiment has the advantage of being the least costly, optical emitters generally being less expensive than optical receivers.

According to another variant, the device comprises two emitting optical elements and two receiving optical elements associated in pairs, each receiving element receiving the optical beam from the emitting element in the same pair.

Advantageously, the two optical emitters operate sequentially.

Advantageously, the three optical elements are substantially aligned and the receiving optical element lies between the emitting elements.

The positioning of the elements may be such that that the angle of incidence of the optical beam emitted and received by the optical elements is less than 60°.

The device may comprise at least one collimator device for the optical beam and this collimator device may comprise slits to limit stray interference between light beams.

With this arrangement it is possible to obtain sharper state transitions and improved coupling between the optical emitters and receivers.

According to a variant of embodiment, the device comprises an additional optical emitter who trace on the disc is centred on the axis of symmetry of the disc, the disc being provided with a reflecting zone about this axis.

The invention also concerns a fluid meter comprising a rotating disc that is part of an optical detector device such as specified above.

Finally the invention concerns a detection module intended to cooperate with a fluid meter and comprising said optical elements that are part of a device such as specified above.

Advantageously, this module also comprises a collimation device for the optical beam.

The invention is described below in more detail with the aid of figures which only show one preferred embodiment of the invention.

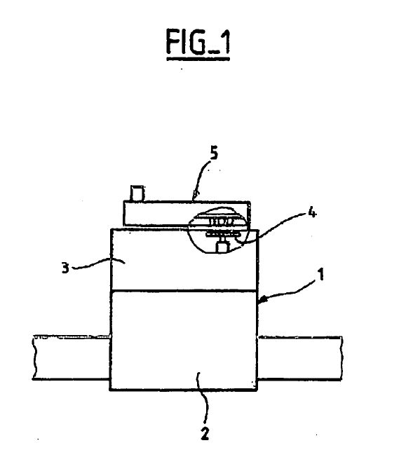

FIG. 1 is a view of the meter and of a module according to the invention.

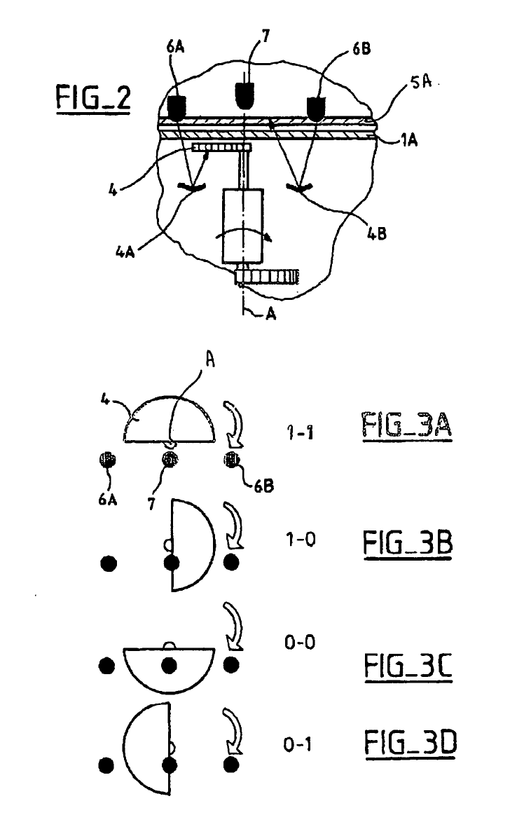

FIG. 2 is a cross-section view of a detection device of the invention according to a first embodiment.

FIG. 3 is an overhead view of a rotating target that is part of a detection device of the invention, in different positions.

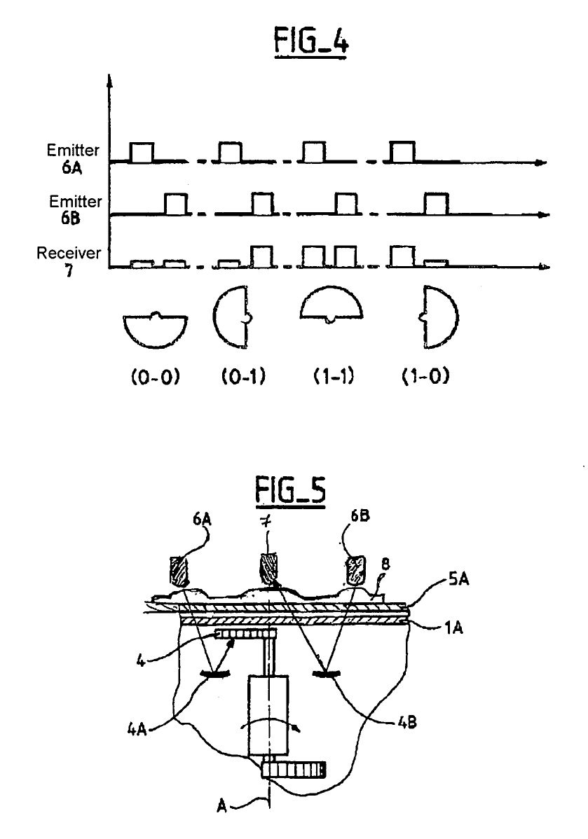

FIG. 4 is a diagram illustrating processing of the data detected by the detection device of the invention.

FIG. 5 is a partial cross-section view of a variant of embodiment of a detection device of the invention.

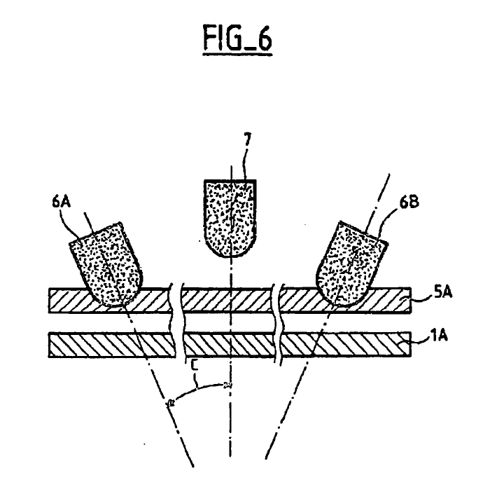

FIG. 6 is partial cross-section view of another variant of embodiment of a detection device of the invention.

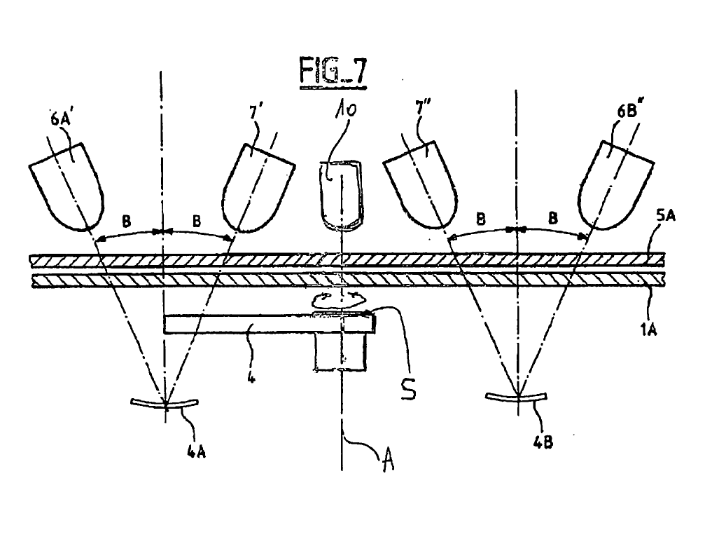

FIG. 7 is a cross-section view of a detection device of the invention according to a third embodiment.

FIG. 1 is a front view of a fluid meter 1, more precisely a water meter, comprising a casing 2 provided with a water inlet pipe and outlet pipe surmounted by a totallizer 3 containing a transmission and shaft rotation gear mechanism for a measuring element such as a turbine or volumetric chamber contained in casing 2 which transmits to a consumption display device not shown, and a rotating indicator target 4 parallel to an upper transparent wall of the totallizer.

An optical detection module 5 whose lower wall is at least partly transparent, is positioned on the upper wall of meter 1 in order to detect water consumption and its direction of flow.

FIG. 2 illustrates the optical detection device of the invention in more detail.

Meter 1 therefore comprises a transparent wall 1A and parallel to this wall is an indicator target 4 driven by a transmission mechanism. This target is a portion of an opaque disc with a centre angle of between 45 and 225° and is preferably 180°.

Arranged so that they arrive opposite the target 4 or in the vicinity thereof when the module is positioned on the meter 1, module 5 comprises three optical elements, more precisely two optical emitters 6A,6B each arranged on either side of an optical receiver 7. When considering axis A of disc 4, the optical receiver 7 is offset from this axis A and the three optical elements 6a, 6B and 7 are aligned parallel to a radius of disc portion 4.

The two emitters 6A, 6B emit a light beam outside target 4 and the detection device also comprises two mirrors 4A, 4B reflecting each optical beam on the pathway of target 4.

Instead of two separate mirrors 4A, 4B as shown, only one mirror may be used ensuring the reflection of the two optical beams emitted by emitters 6A and 6B.

Preferably, the optical emitters 6A, 6B are LED diodes emitting an infrared beam which passes through the two transparent walls 5A, 1A and is reflected on a mirror 4A, 4B.

If this reflected beam is not intercepted by the target 4 (as on the right in FIG. 2), it is received by the optical receiver 7 preferably formed of a photodiode or phototransistor. If it is intercepted by the target 4 (as on the left in FIG. 2), it is not received by the receiver 7.

FIG. 3 shows different relative positions of the target 4 and of emitters 6A, 6B and receiver 7 as seen along a plane perpendicular to axis A of the disc.

The direction of rotation of the disc is shown by an arrow, this direction corresponding to normal positive fluid consumption.

In position 3A, the two beams of emitters 6A, 6B and their reflected beams are located outside target 4. The optical signals sequentially received by receiver 7 are maximum and are derived from the two emitted beams. A pair of values of (1,1) is therefore detected.

In position 3B, the beam from emitter 6A and its beam reflected by mirror 4A are located outside the target 4. The beam from emitter 6B has its beam reflected by mirror 4B which on the other hand is intercepted by target 4. Receiver 7 therefore only receives the first reflected beam and the pair of values detected is (1,0).

In position 3C, the two beams from emitters 6A, 6B have their reflected beams intercepted by the target 4. The optical signal received by receiver 7 is substantially zero. A pair of values of (0,0) is therefore detected.

In position 3D, the beam from emitter 6A has its beam that is reflected by mirror 4A intercepted by target 4. The beam from emitter 6B and its beam reflected by mirror 4B are outside the target 4 however. Receiver 7 therefore only receives the second reflected beam and the detected pair of values is (0,1).

In positive consumption, the series of signals received is therefore (1,1), (1,0), (0,0), (0.1) and the frequency of their state changes makes it possible to determine the speed of rotation of the indicator target 4 and hence consumption. A series comprising one of the preceding pairs in another order enables detection of a change in the direction of rotation of indicator target 4 and hence a negative consumption.

Instead of operating as above, it is possible to seek to identify a small so-called minimum transmission through disc 4, instead of seeking to identify total opacity and zero transmission.

Therefore with the invention it is also possible to detect the positioning of the module on the meter. The signal may have three values:
zero, indicating that the module is not positioned,
minimum, indicating transmission through disc 4,
maximum, indicating transmission outside disc 4.

These signals schematised in square waves are shown in FIG. 4. The processing of these signals does not require any complex electronics and they can be processed directly by a microcontroller.

In the above, for the purpose of simplifying the description, often one light pulse was concerned emitted by diodes 6A, 6B over a quarter rotation of disc 4. According to the invention, the optical emitters 6A, 6B operate in sequence which makes it possible to determine signals and the corresponding states and has the advantage of requiring low overall power consumption. The light beam is emitted in the form of frequency pulses related to the maximum rotation speed of the target.

In the above, optical elements 6A, 6B, 7 are advantageously SMD optical components (Surface Mounted Devices) and are simple i.e. the components have no integrated collimation.

As can be seen in FIG. 5, optical beam collimation devices 8, of lens type, may be inserted between the transparent wall 5A of module 5 and the optical elements 6A, 6B, 7, or they may be formed directly by the transparent wall 5A of module 5 configured as a collimation device.

Optical elements 6A, 6B, 7 here may also be SMD components (Surface Mounted Devices).

FIGS. 6 and 7 illustrate variants of embodiment of the invention.

Although a sealing device may be provided between the reading module and the totallizer, of gasket or press fit type for example, solid or liquid dirt or particles may be deposited on the transparent wall 1A of meter 1, interfering with transmission of the light beam through the transparent walls 1A, 5A of meter 1 and of detection module 5.

As can be seen in FIG. 7, to minimize this interference, optical elements 6A, 6B, 7 are conformed so that the angle of incidence B is very small and preferably less than 60°. Therefore any power losses of the beam due to particles or dirt are minimum and the beam transmitted through the transparent walls remains of high power.

One solution for minimising this angle of incidence B is to choose an adequate distance between the optical elements and the disc, angle B being smaller the greater this distance.

FIG. 6 illustrates another possibility.

Here the optical receiver 7 is arranged with its axis of symmetry oriented in the direction of the light beam perpendicular to the transparent wall 1A of the module, and the two optical emitters 6A, 6B have their own equivalent axis of symmetry in a plane perpendicular to this wall 1A but at an angle C with respect to this axis of symmetry of the central optical receiver 7. Preferably, this angle C is less than 60°. Also the receiver 7 is positioned above the emitting diodes 6A and 6B to avoid any direct coupling between emitter and receiver without passing through the rotating target.

In the above description, the optical detector device of the invention comprises two emitting optical elements and one receiving optical element which receives the two emitted optical beams. These arrangements are particularly economical having regard to the cost of a photodiode or phototransistor.

However, while remaining within the scope of the invention, it is possible to use two emitting optical elements and two receiving optical elements, associated in pairs, each receiving element receiving the optical beam of the emitting element in the same pair.

Said detection device of the invention is shown in FIG. 7.

Two pairs each comprising an optical emitter 6A′, 6B″ and an optical receiver 7′, 7″ are arranged in the module. Each emitter 6A′, 6B″ emits an optical beam through the walls opposite module 5A and meter 1A, and the effects are the same as previously described for FIG. 3.

As has already been seen, in order to minimize interference by solid or liquid dirt or particles in the transmission of the light beam through the transparent walls 1A, 5A of meter 1 and of the detection module 5, the angle of incidence B of the beams is small and preferably less than 60°. For this purpose, the optical elements 6A′,7′, 6B″, 7″ are preferably inclined at this angle B with respect to the plane of symmetry of each pair, perpendicular to the walls of module 5A or meter 1A.

Following the same optical principle, it is possible to provide a detection device to detect the presence of the module on the meter. An optical emitter common to the detection device already described or dedicated to presence detection 10 is then arranged so that its emitted beam is reflected on a reflecting surface S arranged on the disc 4 about the axis of rotation A. The absence of a reflected beam indicates that the module is not positioned on the meter. Any change in this reflected beam indicates that the module is not properly positioned on the meter.

Advantageously, a dedicated additional optical emitter 10 is used for this purpose, this emitter being centred for example on disc 4. More generally, the trace of the optical beam emitted by this emitter on disc 4 is centred on axis A shown in FIG. 3.

1. Optical detector device for a meter, comprising:
a consumption indicator formed of a rotating target and optical elements of emitting type and receiving type of which at least one lies opposite said target, whose received optical signal is processed to infer at least the number of rotations of said disc, having at least two said optical elements of one type and at least one said optical element of the other type, wherein said target is a portion of an opaque disc with a center angle called a first angle (γ) of between about 45 and about 225°, and said two optical elements of one type are emitting elements of a light beam, whose light beam is outside target and in that it also comprises at least one mirror reflecting each optical beam on the pathway of the target.

2. Device as in claim 1, wherein said disc portion has a center angle (γ) of 180°.

3. Device as in claim 1, further comprising two emitting optical elements and one receiving optical element.

4. Device as in claim 3, wherein said three optical members are substantially aligned and the receiving optical element is between the emitting elements.

5. Device as in claim 1, further comprising two emitting optical elements and two receiving optical elements associated in pairs, each receiving element receiving the optical beam of the emitting element in the same pair.

6. Device as in claim 1, wherein the two optical emitters operate in sequentially.

7. Device as in claim 1, wherein the positioning of said optical elements is such that the angle of incidence (B) of the optical beam emitted and received by the optical elements is less than 60°.

8. Device as in claim 1, further comprising at least one collimator device for the optical beam.

9. Device as in claim 8, wherein said collimator device has slits limiting stray interference between light beams.

10. Device as in claim 1, further comprising an additional optical emitter whose trace on the disc is centred on the axis of symmetry (A) of the disc, the disc being provided with a reflecting zone about this axis (A).

11. Fluid meter comprising:
a rotating disc that is part of an optical detector device as in claim 1.

12. A detection module intended to cooperate with a fluid meter and comprising said optical elements that are part of a device as in claim 1.

13. A module as in claim 12, further comprising an optical beam collimator device.
